(19) United States
(12) Patent Application Publication
(10) Pub. No.: US 2007/0101903 A1
(43) Pub. Date: May 10, 2007

(54) Carbon black surface-modified with benzene compound and carbon black dispersion composition for black matrix using the same

(76) Inventors: Kil Sung Lee, Kwacheon-city (KR); Jae Hyun Kim, Seongnam-city (KR); Eui June Jeong, Seoul (KR); Chun Woo Lee, Suwon-city (KR)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/473,876

(22) Filed: Jun. 23, 2006

(30) Foreign Application Priority Data
Nov. 9, 2005 (KR) 10-2005-0106964
Jan. 4, 2006 (KR) 10-2006-0000810

(51) Int. Cl. C09C 1/48

(52) U.S. Cl. 106/476; 106/472

(57) ABSTRACT

Disclosed herein are carbon black surface-modified with benzene compound of Formula 1 described in the specification and a carbon black dispersion composition for a black matrix using the carbon black. The carbon black dispersion composition uses carbon black surface-modified with the benzene compound of Formula 1, or about 0.1 to about 20% by weight of a cardo compound selected from cardo monomers, oligomers, polymers and mixtures thereof. The carbon black dispersion composition can provide improved adhesive properties, uniformity and resolution of black matrix patterns, and no undercut is formed on the black matrix patterns.

### FIELD OF THE INVENTION

The present invention relates to a carbon black dispersion composition suited for the formation of a black matrix used to produce a color filter of a liquid crystal display. More particularly, the present invention relates to an improvement in the uniformity and resolution of a black matrix pattern for a color filter of a liquid crystal display by using a carbon black dispersion composition comprising carbon black as a major component, an organic dispersant, a polymer and other additives in the formation of the black matrix.

### BACKGROUND OF THE INVENTION

Color filters are generally produced by forming a black matrix (frame) on the surface of a substrate made of a transparent material, such as glass or a sheet-type resin, and sequentially forming mosaic pixels (color patterns) using three or more different colors, including red (R), green (G) and blue (B) colors. Representative methods for producing color filters are dyeing, printing, pigment dispersion, electrodeposition, and other methods.

Of these, pigment dispersion methods are mainly employed to produce color filters. According to pigment dispersion methods, color filters are produced by applying a photosensitive composition comprising a pigment to a transparent substrate, exposing the coated substrate to light through a patterned photomask, developing the exposed substrate using an aqueous alkaline solution as a developer, and curing (drying) the developed substrate at a high temperature. Pigment dispersion methods are known to have advantages of high precision in the position of pixels on the color filters and film thickness, superior physical properties, including superior stability against light, heat and chemicals, and few defects (e.g., pinholes).

Generally, a black matrix is formed in a lattice, linear or mosaic arrangement between R, G and B pixels formed on a color filter, and plays a role in inhibiting mixing of colors to achieve improved contrast and in preventing the malfunction of a thin-film transistor (TFT) caused due to leakage of light emitted from backlight units. Accordingly, black matrices are required to have good light-shielding properties. The degree of light-shielding properties of black matrices is expressed as an optical density (OD) value. The optical density value is expressed as an absolute value of the common logarithm of a transmittance measured at a particular wavelength or a particular wavelength range, which indicates that the higher the OD value, the better the light-shielding properties of a black matrix.

Conventional black matrices are formed by forming a metal or a metal oxide, such as chromium or chromium oxide, into a thin film. Specifically, conventional black matrices are formed by depositing a metal, e.g., chromium, on a transparent substrate, treating the deposited substrate by photolithography, and etching the metal layer. Although the conventional black matrices thus formed exhibit superior light-shielding properties because of their small film thickness and high precision, they have drawbacks that the formation procedure is complicated and dangerous, high costs are involved due to low productivity, and environmental problems are caused by waste solutions generated during etching.

Under these circumstances, methods for forming non-toxic resin-based black matrices have recently been introduced. According to these methods, a light-shielding material and an organic pigment, such as non-toxic carbon black, are dispersed in a metal or metal oxide (e.g., chromium or chromium oxide) to prepare a photosensitive resin, and using the photosensitive resin in the formation of black matrices.

Conventional methods for forming black matrices by using carbon black are disclosed in Japanese Patent Laid-open No. 2004-292672, U.S. Pat. No. 4,762,752, Japanese Patent Laid-open No. Hei 10-204321, Japanese Patent Laid-open No. 2004-251946, Japanese Patent Laid-open No. 2004-29745, Japanese Patent Laid-open No. 2004-4762, Japanese Patent Laid-open No. 2004-75985, Japanese Patent Laid-open No. 2004-198717, Korean Patent No. 2002-0075502, Japanese Patent Laid-open No. Hei 11-60989, Japanese Patent Laid-open No. Hei 10-253820, Japanese Patent Laid-open No. Hei 10-10311, Japanese Patent Laid-open No. Hei 9-22653, etc. Most of these conventional methods are associated with primary particles of carbon black, kinds according to the structures of the primary particles of carbon black, and the surface modification of carbon black and the kind of surface-modifying agents for imparting superior resistance and dispersibility to the carbon black. Although the characteristics of carbon black dispersions, including stability, light-shielding properties, adhesive properties and resistance, are improved by conventional methods, no mention is made regarding the uniformity and resolution of black matrix patterns. Japanese Patent Laid-open No. 2004-198717, which was filed by Showa Denko KK, Japan, teaches an improvement in the resolution of black matrix patterns, but few studies have been done to satisfy the level required by liquid crystal display manufacturers.

As liquid crystal screens become larger from those of mobile devices (e.g., cell phones and notebooks) and computer monitors to those of television (TV) sets, the brightness of the liquid crystal screens has been an important factor determining the quality of liquid crystal displays. Taking into consideration the fact that high fineness of black matrices for color filters contributes to an improvement in the brightness of liquid crystal screens, the uniformity and resolution of black matrix patterns are gaining importance.

### SUMMARY OF THE INVENTION

The present invention can provide a pigment dispersion composition for a black matrix using carbon black wherein the pigment dispersion composition improves the uniformity and resolution of a black matrix pattern as compared to conventional pigment dispersion compositions.

The present invention also can provide a method for preparing the pigment dispersion composition.

In accordance with one aspect of the present invention, there is provided carbon black surface-modified with a benzene compound of Formula 1 below:

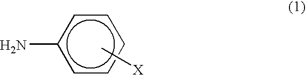

wherein X is H, COOH, COONa, Ph, substituted Ph, SO₃H, SO₃Na, NO₂, halide, C₁-C₅ alkyl, or the like.

In one embodiment, the carbon black is surface-modified with about 0.5 to about 2.5 μmol/m² of the benzene compound.

In one embodiment, the carbon black has a dibutyl phthalate (DBP) oil absorption of about 30 ml/100 g to about 100 ml/100 g.

In accordance with another aspect of the present invention, there is provided a carbon black dispersion composition for a black matrix comprising the carbon black surface-modified with the benzene compound, a dispersant, and a solvent.

In accordance with another aspect of the present invention, there is provided a carbon black dispersion composition for a black matrix comprising carbon black, a dispersant and a solvent, and further comprising a cardo compound selected from cardo monomers, cardo oligomers, cardo polymers, and mixtures thereof.

In one embodiment, the carbon black dispersion composition comprises about 0.1 to about 20% by weight of the cardo compound selected from cardo monomers, cardo oligomers, cardo polymers, and mixtures thereof.

In one embodiment, the carbon black dispersion composition comprises about 5 to about 40% by weight of the carbon black, about 1 to about 10% by weight of the dispersant, about 0.1 to about 20% by weight of the cardo compound, and about 30 to about 90% by weight of the solvent.

In one embodiment, the cardo compound includes about 0.1 to about 20% by weight of a cardo polymer.

In one embodiment, the cardo compound includes about 0.1 to about 20% by weight of a cardo monomer or oligomer.

In one embodiment, the carbon black has a dibutyl phthalate (DBP) oil absorption of about 30 ml/100 g to about 100 ml/100 g.

In one embodiment, the dispersant is a modified polyurethane block copolymer having a molecular weight of about 5,000 to about 20,000.

In one embodiment, the cardo polymer has a molecular weight of about 1,000 to about 8,000 and is represented by Formula 2 below: 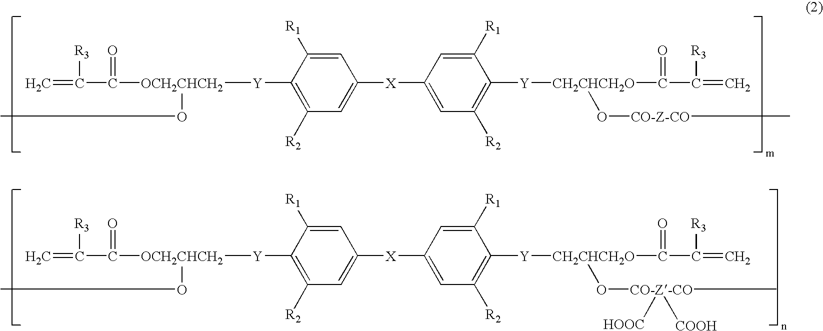
wherein R₁ and R₂ are each independently a hydrogen atom, C₁-C₃₀ alkyl, or a halogen atom,

R₃ is a hydrogen atom or a methyl group,

X is 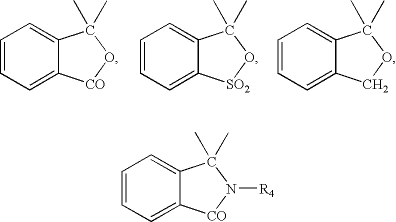
(R₄ is H, Et, C₂H₄Cl, C₂H₄OH, CH₂CH═CH₂ or Ph),

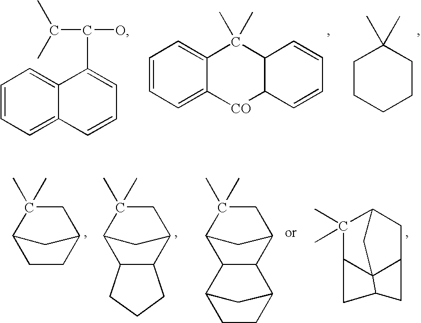

Y is —O—, —NR₅— (in which R₅ is H, Me, Et, CH₂OH, C₂H₄OH or CH₂CH═CH₂), or —C(═O)O—, and

Z and Z′ are each independently a derivative of an acid monoanhydride or dianhydride.

In one embodiment, the cardo monomer or oligomer is represented by Formula 3 below:

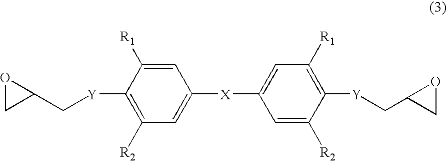

wherein R₁ and R₂ are each independently a hydrogen atom, C₁-C₃₀ alkyl or a halogen atom,
X is 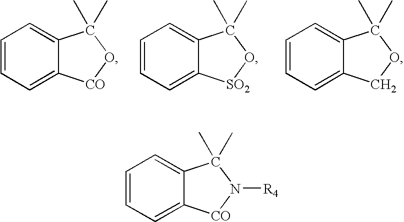
   (R₄ is H, Et, C₂H₄Cl, C₂H₄OH, CH₂CH═CH₂ or Ph),

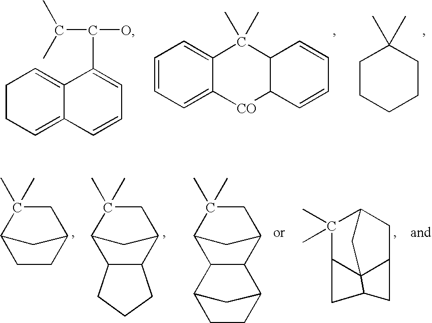

Y is —O—, —NR₅— (in which R₅ is H, Me, Et, CH₂OH, C₂H₄OH or CH₂CH═CH₂), or —C(═O)O—.

In one embodiment, the cardo compound includes about 0.5 to about 10% by weight of the cardo polymer.

In one embodiment, the cardo compound includes about 0.1 to about 10% by weight of the cardo monomer or oligomer.

In one embodiment, the carbon black is surface-modified with about 0.5 to about 2.5 μmol/m² of a benzene compound of Formula 1 below: 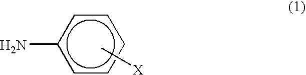
wherein X is H, COOH, COONa, Ph, substituted Ph, SO₃H, SO₃Na, NO₂, halide, C₁-C₅ alkyl, or the like.

In one embodiment, the carbon black dispersion composition further comprises about 0.1 to about 10% by weight of a dispersion assistant.

In one embodiment, the dispersion assistant is a quaternary ammonium salt of Formula 4 below:

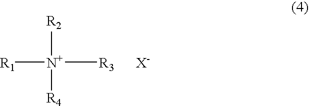

wherein R₁ to R₄ are each independently C₁-C₂₀ alkyl, benzyl, aryl, or X⁻ (e.g., Cl⁻, Br⁻ or I⁻).

In one embodiment, the solvent is selected from propylene glycol monomethyl ether acetate, cyclohexanone, ethyl 3-ethoxypropionate, ethyl cellosolve, polyethylene glycol, and mixtures thereof.

In accordance with another aspect of the present invention, there is provided a black matrix for a color filter formed using the carbon black dispersion composition.

In accordance with yet another aspect of the present invention, there is provided a color filter comprising the black matrix.

### BRIEF DESCRIPTION OF THE DRAWINGS

The above and other features and other advantages of the present invention will be more clearly understood from the following detailed description taken in conjunction with the accompanying drawings, in which:

FIG. 1 is a magnified photograph (500×) of a black matrix pattern (25 μm) formed using a carbon black dispersion composition of the present invention;

FIG. 2 is a magnified photograph (3,000×) of a black matrix pattern (25 μm) formed using a carbon black dispersion composition of the present invention;

FIG. 3 is a photograph showing poor linearity of a pattern formed in Comparative Example 1; and

FIG. 4 is a photograph showing formation of undercuts in a pattern formed in Comparative Example 1.

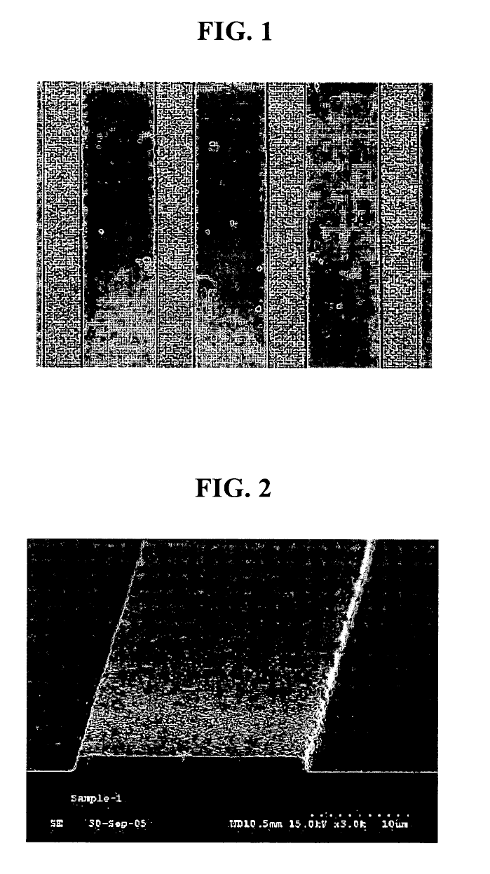

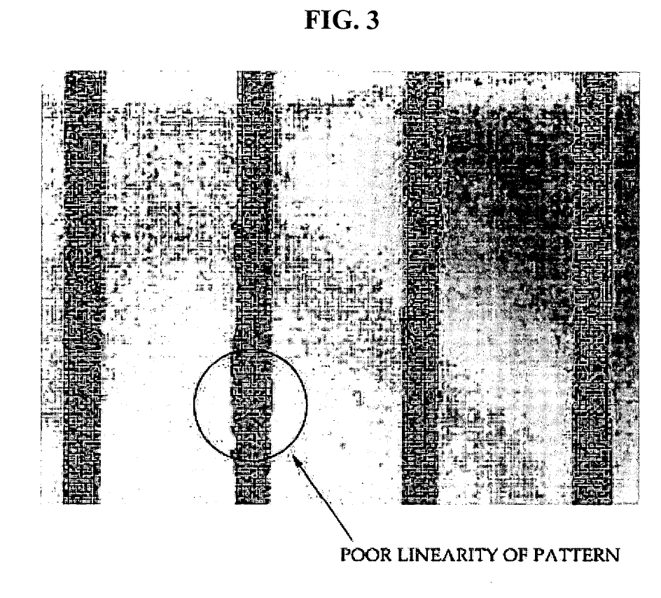

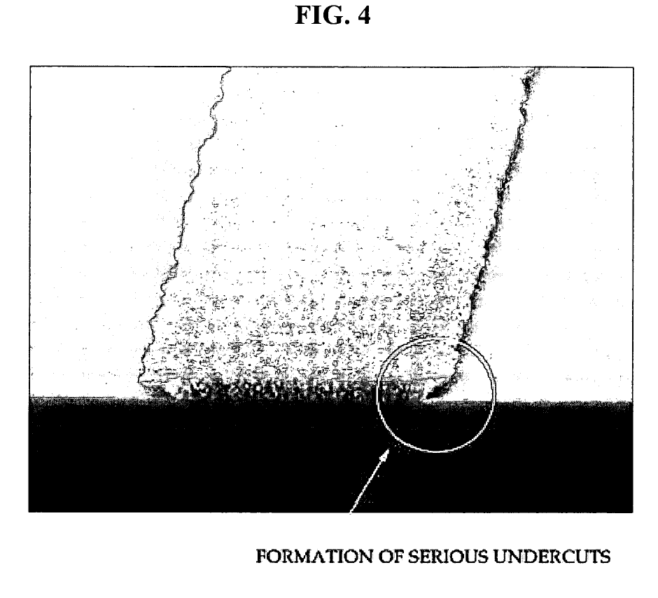

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention provides a carbon black dispersion composition for a black matrix used to produce a color filter of a liquid crystal display wherein the composition comprises carbon black, a dispersant, and a solvent. The present invention also provides a carbon black dispersion composition for a black matrix which comprises from about 5 to about 40% by weight of carbon black, from about 1 to about 10% by weight of a dispersant, from about 0.1 to about 20% by weight of a cardo compound selected from cardo monomers, cardo oligomers, cardo polymers and mixtures thereof, and from about 30 to about 90% by weight of a solvent.

The carbon black can have a primary particle diameter of about 10 to about 60 nm, for example, about 20 to about 40 nm. When the carbon black has a particle diameter smaller than about 10 nm, it is not readily dispersed. Meanwhile, when the carbon black has a particle diameter exceeding about 60 nm, the OD value is undesirably lowered. Preparation processes of the carbon black are not particularly restricted, and examples of the carbon black include oil furnace black, gas furnace black, thermal black, acetylene black, channel black, and the like, and mixtures thereof.

The carbon black can have a primary particle diameter within the range defined above and be especially surface modified. For the purpose of improving the dispersibility of carbon black in organic solvents and of enhancing the uniformity and resolution of black matrices, carbon black is surface modified by introducing an organophilic group into the surface of the carbon black. The surface modification of the carbon black used in the present invention is performed using the benzene compound of Formula 1.

Structure 1 of surface-modified carbon black:

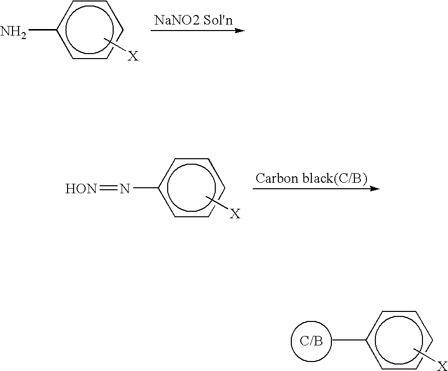

wherein X is H, COOH, COONa, Ph, substituted Ph, SO₃H, SO₃Na, NO₂, halide, C₁-C₅ alkyl, or the like.

The performance of black matrices is greatly dependent on the kind and amount of surface-modifying agents of carbon black used. The selection of suitable surface-modifying agents can be determined depending on the kind and amount of photosensitive resin solutions and polymers. For example, in the case where a cardo polymer is used to prepare a photosensitive resin solution for a black matrix and dipentaerythritol hexaacrylate (DPHA) is used as a crosslinking agent, the use of SO₃Na (or SO₃H) and COONa(or COOH) as the substitutent X provides better results in the uniformity and resolution of a black matrix than the use of C₁-C₅ alkyl as the substitutent X.

When the substitutent X is COONa (or COOH), the performance of black matrices may also vary depending on the degree of substitution. The degree of substitution can be from about 0.5 to about 2.5 μmol/m². If the degree of substitution with COONa (or COOH) is below about 0.5 μmol/m², the dispersibility of the carbon black is not sufficiently improved. Meanwhile, if the degree of substitution is above about 2.5 μmol/m², overdevelopment takes place during development using an aqueous alkaline solution, causing a decrease in the line width and uniformity of black matrix patterns and particularly causing poor linearity and undercuts of patterns. Accordingly, in view of the foregoing, it can be helpful to select surface-modifying agents.

When it is intended to convert the substituent (e.g., COONa or SO₃Na) in a salt form to carboxylic acid, a corresponding material is treated with a hydrochloric acid (about 1 wt %) solution and sufficiently washed before being dried or a diazo compound is prepared in hydrochloric or nitric acid (pH≦4), followed by reaction with carbon black, as depicted in the following formula.

Structure 2 of surface-modified carbon black:

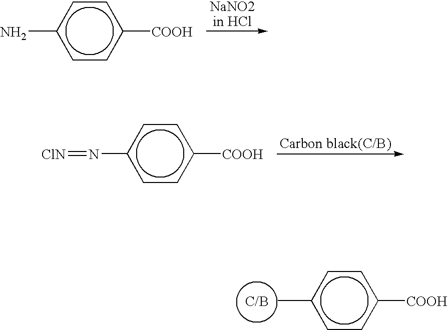

The dibutyl phthalate (DBP) oil absorption of the surface-modified carbon black is preferably in the range of about 30 ml/100 g to about 100 ml/100 g. Below about 30 ml/100 g, the structure of the carbon black is too small and thus it is not readily dispersed. Above about 100 ml/100 g, the structure of the carbon black is too large and large voids are formed between the carbon black particles, leading to a low fill rate of the carbon black particles per unit volume. This low fill rate makes it impossible to attain sufficient light-shielding properties.

The dispersant used in the present invention is preferably a modified polyurethane block copolymer having a molecular weight of about 5,000 to about 20,000. When the dispersant has a molecular weight of less than about 5,000, sufficient dispersibility is not attained. Meanwhile, when the dispersant has a molecular weight exceeding about 20,000, the adhesion properties of a black matrix pattern are poor, causing a loss of the pattern. As a result, the resolution of the pattern is deteriorated.

Suitable dispersants that can be used in the present invention are those containing toluene diisocyanate and hexadecanol modified polycaprolactone as major components. These dispersants may be prepared in situ or commercially available products. Examples of commercially available dispersant products include: Disperbyk 161, Disperbyk 163, Disperbyk 164, Disperbyk 166, Disperbyk 167 and Disperbyk 169, all of which are purchased from BYK; Solsperse 24000, Solsperse 32550, Solsperse 38500 and Solsperse 31845, all of which are purchased from Avecia; and EFKA 4046 and EFKA 4047, all of which are purchased from EFKA. These dispersants have an amine value of about 10 to about 20 mgKOH/g.

The amine value of the dispersant used in the present invention does not especially affect the dispersibility of the dispersant and the performance of a black matrix.

The cardo compound used in the present invention can be a cardo monomer, a cardo oligomer, a cardo polymer, or a mixture thereof. The cardo polymer has a structure of Formula 2 below: 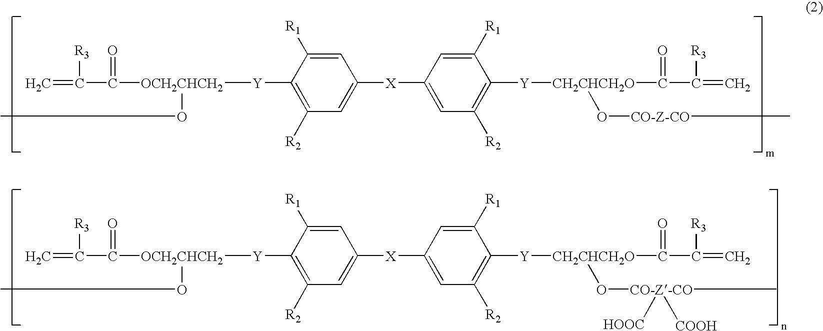
wherein R₁ and R₂ are each independently a hydrogen atom, an alkyl group (for example C₁-C₃₀ alkyl), or a halogen atom,

R₃ is a hydrogen atom or a methyl group,
X is 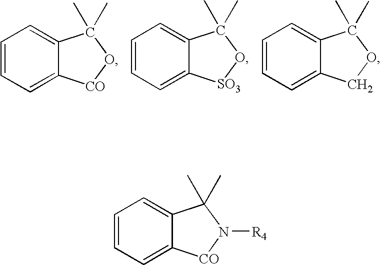
   (R₄ is H, Et, C₂H₄Cl, C₂H₄OH, CH₂CH═CH₂ or Ph),

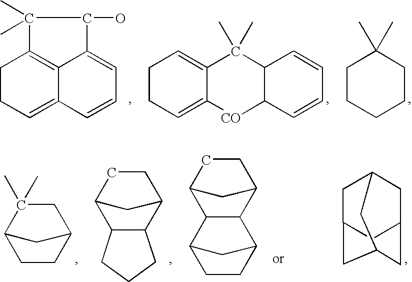

Y is —O—, —NR₅— (in which R₅ is H, Me, Et, CH₂OH, C₂H₄OH or CH₂CH═CH₂), or —C(═O)O—, and Z and Z′ are each independently a derivative of an acid monoanhydride or dianhydride.

The cardo polymer used in the present invention can be identical or similar to a cardo polymer used in the preparation of a photosensitive resin solution for a cardo black matrix. The cardo polymer is added in an amount of about 0.1 to about 20% by weight. If the cardo polymer is added in an amount of less than about 0.1% by weight, sufficient performance cannot be anticipated. Meanwhile, if the polymer is added in an amount of more than about 20% by weight, the viscosity of the dispersion is increased, making it difficult to control the film thickness when the composition is applied. The cardo polymer can be added in an amount of about 0.5 to about 10% by weight.

In the present invention, the cardo polymer is not simply added after the preparation of the pigment dispersion, but the polymer is added together with the other components upon dispersion of the pigment to induce co-dispersion of the components, thereby improving the performance of a black matrix, enhancing the stability of the dispersion, and facilitating the dispersion of the components. Any cardo polymer having a molecular weight of about 1,000 to about 8,000 can be used in the present invention. The addition of the cardo polymer markedly contributes to an improvement in the uniformity and resolution of a black matrix pattern.

The cardo monomer or oligomer used in the present invention has a structure of Formula 3 below:

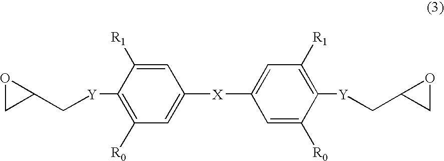

wherein R₁ and R₂ are each independently a hydrogen atom, an alkyl group (for example C₁-C₃₀ alkyl) or a halogen atom,
X is 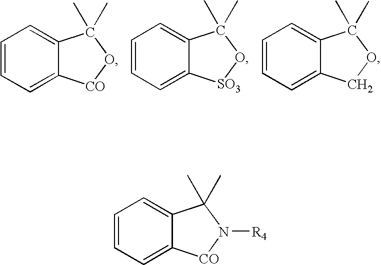
   (R₄ is H, Et, C₂H₄Cl, C₂H₄OH, CH₂CH═CH₂ or Ph),

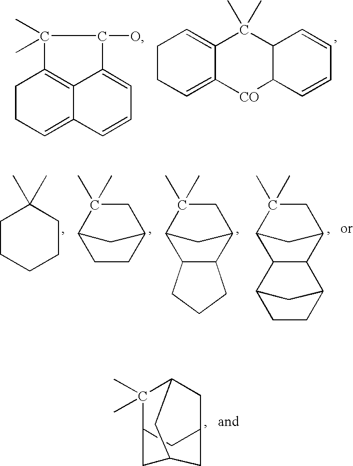

Y is —O—, —NR₅— (in which R₅ is H, Me, Et, CH₂OH, C₂H₄OH or CH₂CH═CH₂), or —C(═O)O—.

The cardo monomer or oligomer participates in photocuring and thermal curing to serve to enhance the uniformity and resolution of a black matrix pattern.

The cardo monomer has a cardo structure containing a glycidyl group, and has a high affinity for the polymer used to prepare a photosensitive resin solution for a black matrix. Further, since the cardo monomer containing a glycidyl group is ring-opening polymerized with the cardo polymer containing a carboxylic acid group during exposure or high-temperature drying, a combination of the cardo monomer and the cardo polymer improves the adhesive properties of the carbon black and enhances the uniformity and resolution of a black matrix pattern. The cardo monomer containing an epoxy group, e.g., a glycidyl group, shows the lowest shrinkage during curing.

The cardo monomer or oligomer is added in an amount of about 0.1 to about 20% by weight. When the cardo monomer is added in an amount of less than about 0.1% by weight, the above effects cannot be sufficiently exhibited. Meanwhile, when the cardo monomer is added in an amount exceeding about 20% by weight, the viscosity of the dispersion is increased, which adversely affects the application of the dispersion, and the amount of the carbon black is relatively decreased after formation of a matrix, which unfavorably lowers the OD value. The cardo monomer or oligomer can be added in an amount of about 0.1 to about 10% by weight. The cardo monomer or oligomer used in the present invention can be prepared from a cardo material and epichlorohydrin as starting materials.

To maximize the dispersion effects, the carbon black dispersion composition of the present invention may further comprise from about 0.1 to about 10% by weight of a dispersion assistant. Examples of suitable dispersion assistants include Solsperse 5000, Solsperse 12000, Solsperse 22000, all of which are purchased from Avecia. These dispersion assistants are copper phthalocyanine pigment derivatives, and serve to impart an affinity for the carbon black, thus providing enhanced dispersibility when compared to the use of the dispersant alone.

To control the particle diameter and particle size distribution of the carbon black dispersion, a quaternary ammonium salt can be used as the dispersion assistant. Any quaternary ammonium salt can be used so long as it has a structure represented by Formula 4 below: 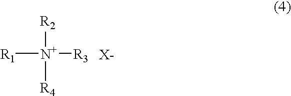
wherein R₁ to R₄ are each independently C₁-C₂₀ alkyl, benzyl, aryl (for example C₆-C₁₀ aryl) or X⁻ (halide, e.g., Cl⁻, Br⁻ or I⁻).

Particularly, the quaternary ammonium salt acts to increase the particle size of the dispersion by about 10 to about 20 nm, compared to when the quaternary ammonium salt is not used.

Examples of the quaternary ammonium salt having the structure of Formula 4 include tetramethylammonium chloride, tetraethylammonium chloride, tetrabutylammonium chloride, lauryltrimethylammonium chloride, hexadecyltrimethylammonium chloride, octadecyltrimethylammonium chloride, dimethyldilaurylammonium chloride, and the corresponding bromides and iodides thereof. These quaternary ammonium salts may be used alone or in combination as a mixture. The quaternary ammonium salt used in the present invention can be added in an amount of about 0.1 to about 2% by weight. When the amount of the quaternary ammonium salt added is below about 0.1% by weight, the dispersion effects cannot be maximized. Meanwhile, the addition of the quaternary ammonium salt in an amount exceeding about 2% by weight causes an increase in the viscosity of the dispersion and is disadvantageous from the economical viewpoint.

Taking the ease of workability during production of a color filter and the compatibility with the other components of a photosensitive resin solution into consideration, the solvent used in the present invention can be a high-boiling point organic solvent. Examples of suitable solvents include propylene glycol monomethyl ether acetate (PGMEA), cyclohexanone, ethyl 3-ethoxypropionate, ethyl cellosolve, and polyethylene glycol. These solvents may be used alone or in combination as a mixture.

The dispersion can be commonly achieved by processes using beads, processes using rotors and stators, high-pressure dispersion processes using orifices, and the like. For example, according to a process using beads, beads made of zirconium oxide and having a size of about 0.1 to about 0.8 mm can be used in consideration of the dispersion time and the particle size and size distribution of the dispersion.

The present invention also provides a black matrix for a color filter formed using the carbon black dispersion composition.

The present invention also provides a color filter comprising the black matrix.

Hereinafter, the present invention will be explained in more detail with reference to the following specific examples. However, these examples are given for the purpose of illustration and are not to be construed as limiting the scope of the invention.

### EXAMPLE 1

1) Preparation of Surface-Modified Carbon Black

300 g of carbon black (Special black 100, Degussa) and 3.4 g of p-aminobenzoic acid are placed in a planetary mixer (Daehawa Tech.) equipped with a 1L-reactor. The carbon black used herein has a BET specific surface area of 30 m²/g and a DBP oil absorption of 94 ml/100 g. The mixture is stirred in the planetary mixer at a revolution speed of 80 rpm and a rotation speed of 250 rpm for 30 minutes. After a solution of sodium nitrite (NaNO₂) in 300 ml of deionized water is added to the planetary mixer, the mixture is further stirred for one hour. The mixture is withdrawn from the mixer and dried in an oven at 90° C. for 5 hours, giving carbon black substituted with sodium p-benzoate. The carbon black product is found to contain 1.2 vol % of volatile components and be surface-modified with 1.5 μmol/m² of sodium p-benzoate, as measured by thermogravimetric analysis (TGA).

2) Preparation of Dispersion

300 g of zirconium oxide beads (0.5 mm) are charged into a one liter basket mill equipped with an agitator and a cooling jacket, and then 380 g of PGMEA are added to the mill. After 90 g of a surface modified carbon black prepared from 1), 26 g of a dispersant (Disperbyk 161, BYK), 18 g of a cardo polymer (molecular weight: 3,000), and 4 g of 4,4′-(9-fluorenylidene)diphenolglycidyl ether are added to the mill, the mixture is dispersed at 1,000 rpm, 15° C. for 4 hours. The particle diameter and the viscosity of the dispersion are measured using a particle size analyzer (LB 500, Horiba, Japan) and a viscometer (DV-II+Pro), respectively.

The average particle diameter, viscosity and dispersion stability of the dispersion are measured, and the results are shown in Tables 1 and 2.

### EXAMPLES 2 TO 12

Dispersions are prepared in the same manner as in Example 1, except that the primary particle diameter of carbon black and the kind and amount of surface-modifying agents are changed as indicated in Tables 1 and 2.

### EXAMPLES 13 AND 14

Dispersions are prepared in the same manner as in Examples 11 and 12, except that 4 g of hexadecyltrimethylammonium bromide is further used as a dispersion assistant.

### EXAMPLE 15

A dispersion is prepared in the same manner as in Example 1, except that surface-unmodified carbon black is used as indicated in Table 1.

### COMPARATIVE EXAMPLES 1 TO 3

Dispersions are prepared in the same manner as in Example 1, except that the primary particle diameter of surface-unmodified carbon black is changed as indicated in Table 1 and no cardo compound is used.

### EXAMPLE 16

3) Preparation and Evaluation of Photosensitive Resin Solutions for Black Matrices

5.0 g of a cardo polymer, 0.7 g of a DPHA monomer or oligomer, 0.6 g of a photoinitiator (IRG OXE01, Ciba Specialty) and 60 g of PEMEA as a solvent are added to 32.0 g of the dispersion prepared in Example 1. The mixture is stirred using a homogenizer for one hour, filtered through a depth filter (20 μm) to prepare a photosensitive resin solution. The solution is applied to a glass substrate (10×10 cm) by spin coating, dried at 80° C., irradiated at 100 mJ/cm² using an exposure system (Ushio, Japan) equipped with photomasks having various shapes and sizes (1-25 μm), and developed with a KOH solution (430 ppm) at 23° C. The developed substrate is cleaned, and dried at a high temperature of 220° C. for 40 minutes to form black matrix patterns. The linearity and resolution of the black matrix patterns are observed under an optical microscope. The cross section of the patterns is observed under a scanning electron microscope (SEM). The dispersion stability of the patterns is evaluated by measuring changes in average particle diameter and viscosity after the patterns are left to stand in an oven at 40° C. for 30 days. The resolution of the patterns is evaluated as the smallest size of patterns remaining after developing among particular patterns having a size of 1-25 μm. The results are shown in Table 2.

### EXAMPLES 17 AND 18

Each of the dispersions (32.0 g) prepared in Examples 2 and 3 and the compositions indicated in Table 3 are used to prepare photosensitive resin solutions for black matrices. The evaluation of the photosensitive resin solutions is performed by the same procedure as in Example 16, and the results are shown in Table 3.

### EXAMPLE 19

The dispersion (32.0 g) prepared in Example 15 and the composition indicated in Table 3 are used to prepare a photosensitive resin solution for a black matrix. The evaluation of the photosensitive resin solution is performed by the same procedure as in Example 16, and the results are shown in Table 3.

### EXAMPLES 20 AND 21

Each of the dispersions (32.0 g) prepared in Examples 13 and 14 and the compositions indicated in Table 3 are used to prepare photosensitive resin solutions for black matrices. The evaluation of the photosensitive resin solutions is performed by the same procedure as in Example 16, and the results are shown in Table 3.

### COMPARATIVE EXAMPLES 4 TO 6

Each of the dispersions (32.0 g) prepared in Comparative Examples 1 to 3 and the compositions indicated in Table 3 (without cardo compound) are used to prepare photosensitive resin solutions for black matrices. The evaluation of the photosensitive resin solutions is performed by the same procedure as in Example 16, and the results are shown in Table 3.

TABLE 1

| | Surface-modified carbon black | | | | | |
|---|---|---|---|---|---|---|
| | | | Amount of | Dispersion | | |
| | | | surface- | Average | | |
| | Primary | Surface- | modifying | particle | | |
| | particle | modifying | agent | diameter | Viscosity | Dispersion |
| | diameter (nm) | agent (X) | (μmol/m²) | (nm) | (mPa · s) | stability |
| Ex. 1 | 50 | p-COONa | 1.5 | 145 | 6.3 | ◯ |
| Ex. 2 | 50 | p-SO₃Na | 1.5 | 150 | 6.3 | ◯ |
| Ex. 3 | 50 | H | 1.5 | 175 | 6.5 | Δ |
| Ex. 4 | 35 | H | 1.5 | 167 | 4.3 | Δ |
| Ex. 5 | 35 | p-SO₃Na | 1.5 | 132 | 4.1 | ◯ |
| Ex. 6 | 35 | p-COONa | 0.5 | 114 | 4.1 | ◯ |
| Ex. 7 | 35 | p-COONa | 1.5 | 110 | 4.1 | ◯ |
| Ex. 8 | 35 | p-COONa | 2.5 | 110 | 3.7 | ◯ |
| Ex. 9 | 25 | H | 1.5 | 180 | 4.7 | Δ |
| Ex. 10 | 25 | p-SO₃H | 1.5 | 143 | 4.6 | ◯ |
| Ex. 11 | 25 | p-COONa | 1.5 | 135 | 4.4 | ◯ |
| Ex. 12 | 15 | H | 1.5 | 220 | 5.6 | Δ |
| Ex. 13 | 25 | p-COONa | 1.5 | 145 | 4.5 | ◯ |
| Ex. 14 | 15 | H | 1.5 | 170 | 5.5 | ◯ |
| Ex. 15 | 50 | Unmodified | — | 195 | 7.1 | Δ |
| Comp. | 35 | Unmodified | — | 280 | 15.5 | X |
| Ex. 1 | | | | | | |
| Comp. | 25 | Unmodified | — | 260 | 22.0 | X |
| Ex. 2 | | | | | | |
| Comp. | 15 | Unmodified | — | 430 | 32.1 | X |
| Ex. 3 | | | | | | |

◯: Change in particle diameter and viscosity ≦±5%,
Δ: ±5%˜±20%,
X ≧±20%

TABLE 2

| | Surface-modified carbon black | | | | | | | | | |
|---|---|---|---|---|---|---|---|---|---|---|
| | | | Amount of | Dispersion | | | | | | |
| | Primary | | surface- | Average | | | | | | |
| | particle | Surface- | modifying | particle | | | Performance of black matrix | | | |
| | diameter | modifying | agent | diameter | Viscosity | Dispersion | Adhesion | | | |
| | (nm) | agent (X) | (μmol/m²) | (nm) | (mPa · s) | Stability | properties | Uniformity | Undercuts | Resolution |
| Ex. 1 | 50 | p-COONa | 1.5 | 145 | 6.3 | ◯ | ⊚ | ⊚ | Not | 7 |
| | | | | | | | | | formed | |
| Ex. 2 | 50 | p-SO₃Na | 1.5 | 150 | 6.3 | ◯ | ⊚ | ◯ | Formed | 7 |
| Ex. 3 | 50 | H | 1.5 | 175 | 6.5 | Δ | ⊚ | ◯ | Not | 7 |
| | | | | | | | | | formed | |
| Ex. 4 | 35 | H | 1.5 | 167 | 4.3 | Δ | ⊚ | ⊚ | Not | 5 |
| | | | | | | | | | formed | |
| Ex. 5 | 35 | p-SO₃Na | 1.5 | 132 | 4.1 | ◯ | ⊚ | ⊚ | Not | 5 |
| | | | | | | | | | formed | |
| Ex. 6 | 35 | p-COONa | 0.5 | 114 | 4.1 | ◯ | ⊚ | ⊚ | Not | 1 |
| | | | | | | | | | formed | |
| Ex. 7 | 35 | p-COONa | 1.5 | 110 | 4.1 | ◯ | ⊚ | ⊚ | Not | 1 |
| | | | | | | | | | formed | |
| Ex. 8 | 35 | p-COONa | 2.5 | 110 | 3.7 | ◯ | ⊚ | ⊚ | Slightly | 15 |
| | | | | | | | | | formed | |
| Ex. 9 | 25 | H | 1.5 | 180 | 4.7 | Δ | ⊚ | ⊚ | Not | 10 |
| | | | | | | | | | formed | |
| Ex. 10 | 25 | p-SO₃H | 1.5 | 143 | 4.6 | ◯ | ⊚ | ⊚ | Not | 10 |
| | | | | | | | | | formed | |
| Ex. 11 | 25 | p-COONa | 1.5 | 135 | 4.4 | ◯ | ⊚ | ⊚ | Not | 5 |
| | | | | | | | | | formed | |
| Ex. 12 | 15 | H | 1.5 | 220 | 5.6 | Δ | ⊚ | ◯ | Not | 15 |
| | | | | | | | | | formed | |
| Ex. 13 | 25 | p- | 1.5 | 145 | 4.5 | ◯ | ⊚ | ⊚ | Not | 10 |
| | | COONa | | | | | | | formed | |
| Ex. 14 | 15 | H | 1.5 | 170 | 5.5 | ◯ | ⊚ | ⊚ | Not | 10 |
| | | | | | | | | | formed | |
| Ex. 15 | 50 | Unmodified | — | 195 | 7.1 | Δ | ◯ | Δ | Slightly | Impossible |
| | | | | | | | | | formed | to evaluate |
| Comp. | 35 | Unmodified | — | 280 | 15.5 | X | X | X | Seriously | |
| Ex. 1 | | | | | | | | | formed | |
| Comp. | 25 | Unmodified | — | 260 | 22.0 | X | X | X | Seriously | |
| Ex. 2 | | | | | | | | | formed | |
| Comp. | 15 | Unmodified | — | 430 | 32.1 | X | X | X | Seriously | |
| Ex. 3 | | | | | | | | | formed | |

TABLE 3

| | | | | | Performance of black matrix | | | |
|---|---|---|---|---|---|---|---|---|
| | Cardo | | Acrylic | | Adhesion | | | |
| | FDPE | Resin | MAA | Resin | properties | Uniformity | Undercut | Resolution |
| Ex. 16 | — | 5.0 | — | — | ⊚ | ◯˜⊚ | Not formed | 5 |
| Ex. 17 | 0.5 | 2.5 | — | — | ⊚ | ⊚ | Not formed | 1 |
| Ex. 18 | 1.0 | 2.5 | — | — | ⊚ | ⊚ | Not formed | 1 |
| Ex. 19 | 0.5 | — | — | — | ⊚ | ◯˜⊚ | Slightly | 5 |
| | | | | | | | formed | |
| Ex. 20 | 0.5 | 0.5 | — | — | ⊚ | ⊚ | Not formed | 1 |
| Ex. 21 | 0.5 | 10.0 | — | — | ⊚ | ⊚ | Not formed | 1 |
| Comp. | — | — | — | 2.5 | X | ◯ | Seriously | 15 |
| Ex. 4 | | | | | | | formed | |
| Comp. | — | — | 0.5 | — | X | X | Seriously | 15 |
| Ex. 5 | | | | | | | formed | |
| Comp. | — | — | 0.5 | 2.5 | X | ◯ | Seriously | 10 |
| Ex. 6 | | | | | | | formed | |

(Unit: wt %)

FDPE: 4,4-(9-fluorenylidene)diphenol glycidyl ether

Cardo resin: M.W. 4,000

MAA: Methylmethacrylate

BZMA: Benzylmethacrylate

Acrylic resin: MAA/BzMA copolymer (M.W. 15,000)

As apparent from the above description, the carbon black dispersion composition for a black matrix according to the present invention selectively uses carbon black surface-modified with an organic compound, or a cardo compound selected from cardo monomers, oligomers, polymers and mixtures thereof. According to the carbon black dispersion composition of the present invention, the adhesive properties, uniformity and resolution of black matrix patterns are improved, and no undercut is formed on the black matrix patterns.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A carbon black surface-modified with a benzene compound of Formula 1 below: 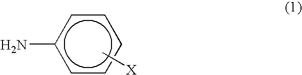
wherein X is H, COOH, COONa, Ph, substituted Ph, SO₃H, SO₃Na, NO₂, halide, or C₁-C₅ alkyl.

2. The carbon black according to claim 1, wherein the carbon black is surface-modified with about 0.5 to about 2.5 μmol/m² of the benzene compound.

3. The carbon black according to claim 1, wherein the carbon black has a dibutyl phthalate (DBP) oil absorption of about 30 ml/100 g to about 100 ml/100 g.

4. A carbon black dispersion composition for a black matrix comprising the carbon black according to claim 1, a dispersant, and a solvent.

5. A carbon black dispersion composition for a black matrix comprising carbon black, a dispersant, a solvent, and a cardo compound selected from cardo monomers, cardo oligomers, cardo polymers, and mixtures thereof.

6. The composition according to claim 5, wherein the carbon black dispersion composition comprises about 0.1 to about 20% by weight of the cardo compound.

7. The composition according to claim 5, wherein the composition comprises about 5 to about 40% by weight of the carbon black, about 1 to about 10% by weight of the dispersant, about 0.1 to about 20% by weight of the cardo compound, and about 30 to about 90% by weight of the solvent.

8. The composition according to claim 5, wherein the cardo compound includes about 0.1 to about 20% by weight of a cardo polymer.

9. The composition according to claim 5, wherein the cardo compound includes about 0.1 to about 20% by weight of a cardo monomer or oligomer.

10. The composition according to claim 5, wherein the carbon black has a dibutyl phthalate (DBP) oil absorption of about 30 ml/100 g to about 100 ml/100 g.

11. The composition according to claim 5, wherein the dispersant is a modified polyurethane block copolymer having a molecular weight of about 5,000 to about 20,000.

12. The composition according to claim 5, wherein the cardo polymer has a molecular weight of about 1,000 to about 8,000 and is represented by Formula 2 below: 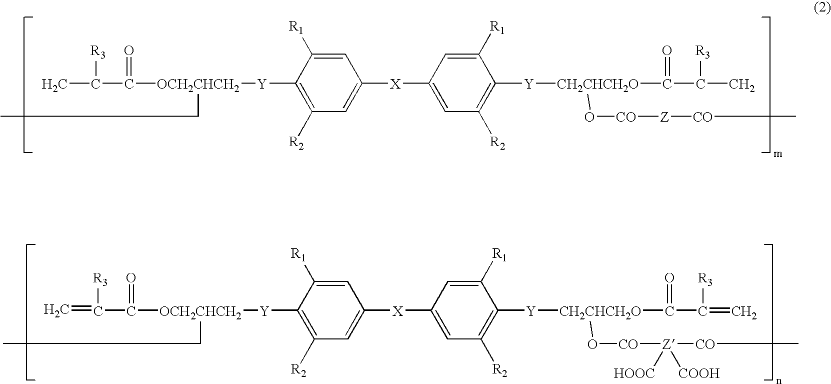
wherein R₁ and R₂ are each independently a hydrogen atom, an alkyl group, or a halogen atom,
R₃ is a hydrogen atom or a methyl group,
X is 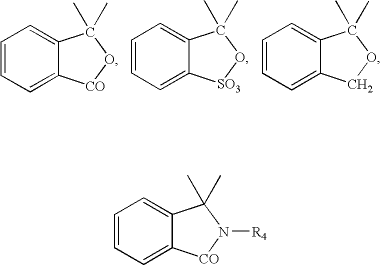
(R₄ is H, Et, C₂H₄Cl, C₂H₄OH, CH₂CH═CH₂ or Ph),
Y is —O—, —NR₅— (in which R₅ is H, Me, Et, CH₂OH, C₂H₄OH or CH₂CH═CH₂), or —C(═O)O—, and Z and Z′ are each independently a derivative of an acid monoanhydride or dianhydride.

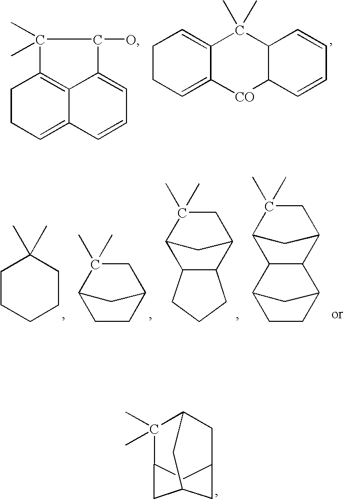

13. The composition according to claim 5, wherein the cardo monomer or oligomer is represented by Formula 3 below: 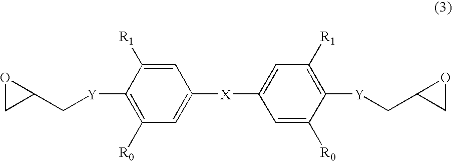
wherein R₁ and R₂ are each independently a hydrogen atom, an alkyl group or a halogen atom,
X is 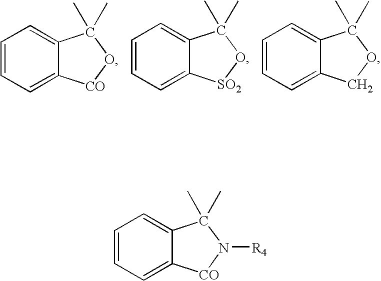
(R is H, Et, C₂H₄Cl, C₂H₄OH, CH₂CH═CH₂ or Ph),
Y is —O—, —NR₅— (in which R₅ is H, Me, Et, CH₂OH, C₂H₄OH or CH₂CH═CH₂), or —C(═O)O—.

14. The composition according to claim 5, wherein the cardo compound includes about 0.5 to about 10% by weight of the cardo polymer.

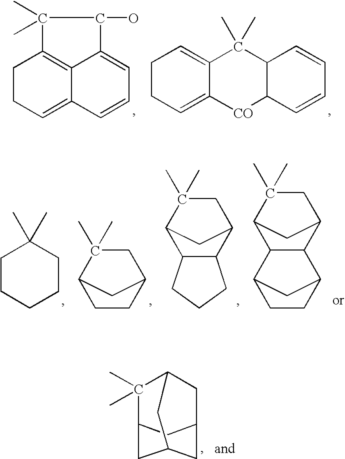

15. The composition according to claim 5, wherein the cardo compound includes about 0.1 to about 10% by weight of the cardo monomer or oligomer.

16. The composition according to claim 5, wherein the carbon black is surface-modified with about 0.5 to about 2.5 μmol/m² of a benzene compound of Formula 1 below: 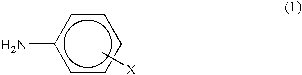
wherein X is H, COOH, COONa, Ph, substituted Ph, SO₃H, SO₃Na, NO₂, halide, or C₁-C₅ alkyl.

17. The composition according to claim 5, further comprising about 0.1 to about 10% by weight of a dispersion assistant.

18. The composition according to claim 17, wherein the dispersion assistant is a quaternary ammonium salt of Formula 4 below: 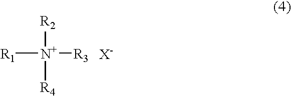
wherein R₁ to R₄ are each independently C₁-C₂₀ alkyl, benzyl, aryl, or X⁻, wherein X⁻ is Cl⁻, Br⁻ or I⁻.

19. The composition according to claim 5, wherein the solvent is selected from propylene glycol monomethyl ether acetate, cyclohexanone, ethyl 3-ethoxypropionate, ethyl cellosolve, polyethylene glycol, and mixtures thereof.

20. A black matrix for a color filter formed using the carbon black dispersion composition according to claim 5.

21. A color filter comprising the black matrix according to claim 20.
